(19) United States
(12) Patent Application Publication
(10) Pub. No.: US 2005/0210215 A1
(43) Pub. Date: Sep. 22, 2005

(54) Semiconductor device permitting rapid data reading and writing between processor and memory

(75) Inventors: Toshihiro Sezaki, Itami-shi (JP); Yuji Ueki, Itami-shi (JP); Yoshikazu Masao, Hyogo (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: Renesas Technology Corp., Tokyo (JP)

(21) Appl. No.: 11/081,643

(22) Filed: Mar. 17, 2005

(30) Foreign Application Priority Data
Mar. 19, 2004 (JP) 2004-080227

(51) Int. Cl. G06F 12/00

(52) U.S. Cl. 711/167

(57) ABSTRACT

In a read operation, a memory circuit successively performs precharge, sense operation and data output operation, each in 0.5 cycle of a clock signal. A write detection circuit, in response to switching from a write operation to a read operation, sends a signal to the memory circuit to make it delay the read operation. The memory circuit delays the read operation by one cycle of the clock signal to prevent destruction of write data. Further, the write detection circuit sends to a processor a signal for switching whether to access the data bus or not, and causes the processor to stop access to the data bus while the read operation is being delayed. Thus, a semiconductor device that can increase data read speed while guaranteeing sufficient data read time from the memory circuit to the data bus is provided.

### BACKGROUND OF THE INVENTION

1. Field of the Invention

The present invention relates to semiconductor devices, and more particularly to a semiconductor device permitting rapid input/output of data between a processor and a memory circuit.

2. Description of the Background Art

In recent years, microcomputers have been incorporated into various apparatuses, let alone the household electrical appliances. To achieve an apparatus improved in function, the microcomputer should be made to conduct a large amount of processing, which requires acceleration of the operation of the microcomputer.

FIG. 7 shows a configuration of a main part of a microcomputer.

Referring to FIG. 7, a microcomputer 100 includes a processor 102 performing data processing, a memory circuit 104 temporarily storing data and inputting/outputting the data in accordance with an instruction from processor ˜02, an address bus AD 1 transmitting an address signal ADR from processor 102 to memory circuit 104, and a data bus DB1 transmitting data between processor 102 and memory circuit 104.

Although not shown in FIG. 7, microcomputer 100 further includes other circuits such as a clock generation circuit generating a clock signal serving as a reference signal to allow respective circuits to operate in synchronization. Similarly although not shown in FIG. 7, memory circuit 104 includes memory cells storing information, bit lines connected to the memory cells, a precharge circuit performing an operation to set a voltage of a bit line pair to a prescribed voltage (hereinafter, also referred to as precharge) at the time of reading or writing of data with respect to the memory cell, a read/write control circuit connected to the bit line pair and performing reading or writing of data with respect to the memory cell, and others.

Processor 102 is, e.g., a central processing unit (CPU). Memory circuit 104 is, e.g., a static random access memory (SRAM) circuit.

Processor 102 sends an address signal ADR and a signal RWS to memory circuit 104. Memory circuit 104 receives address signal ADR and signal RWS, and performs either data read or data write with respect to an address designated by address signal ADR.

FIG. 8 is a timing chart illustrating an operation of microcomputer 100 in FIG. 7.

Referring to FIG. 8, firstly, when a clock signal CLK generated within microcomputer 100 rises before time t1, address signal ADR is switched to designate an address A1. Before time t1, signal RWS is in a state of “1” indicating data read.

Addresses A1-A3 shown in FIG. 8 are arbitrary addresses of memory circuit 104.

Next, at time t1, precharge is conducted. A signal CHR is for activating a precharge circuit. Upon rising of signal CHR, precharge is conducted for the bit line pair.

At time t2, the read/write control circuit performs a read operation. A signal SNS is for activating the read operation. Upon rising of signal SNS, data is transmitted from a memory cell to a bit line pair, and there occurs a voltage difference between the voltages of the bit lines. At time t2, the voltage difference is amplified to a level sufficient to determine whether it corresponds to data of “0” or “1” (hereinafter, this amplification operation is referred to a “sense operation”).

Further, at time t2, data is transmitted from the read/write control circuit to data bus DB1. When a signal OTS controlling the data transmission rises, the data read from the memory cell is output to data bus DB1. A signal DTA indicates a change in level on data bus DB1. At time t2, read data RD read out of address A1 is output to data bus DB1.

At time t2, address signal ADR is switched again, to designate an address A2. Further, at time t2, signal RWS falls to “0”, and writing of data to address A2 is designated.

Next, at time t3, signal CHR rises, and precharge is conducted for the bit lines, as in the operation at time t1.

At time t4, write data WD is output from processor 102 to data bus DB1. The write data WD output to the data bus is sent via data bus DB1 to address A2 of memory circuit 104 to be written therein.

Further, at time t4, address signal ADR is switched, and signal RWS rises to “1”. At time t4, a read operation for an address A3 is started. The operation of reading data from address A3 during the time period from t5 to t7 is identical to the operation of reading data from address A1 during the time period from t1 to t3, and thus, description thereof is not repeated.

As seen from the timing chart of FIG. 8, precharge is performed at time t1, and the output of read data RD from memory circuit 104 to data bus DB1 is completed at time t3. This corresponds to one cycle of clock signal CLK. Similarly, the time period from time t3, when precharge is conducted, to time t5, when the output of write data WD from memory circuit 104 to data bus DB1 is completed, corresponds to one cycle of clock signal CLK. Such an operation of memory circuit 104 performing reading or writing in one cycle of clock signal CLK is hereinafter referred to as “one cycle access”.

In the case of the one cycle access, as seen from the operation waveforms through time period t2-t3 in FIG. 8, memory circuit 104 needs to conduct the sense operation and the outputting of data to data bus DB1 simultaneously. If the driving potential of the sense amplifier is low and thus the operation of the sense amplifier is slow, or if the load such as parasitic capacitance occurring in the bit line pair or the data bus is large and thus it takes time to amplify the voltage difference of the bit line pair, then the data reading takes time, resulting in a delay of the data output. As the read speed cannot be increased, it is difficult to accelerate the operation of microcomputer 100.

As a way of addressing such a problem in the read operation, for example, Japanese Patent Laying-Open No. 2000-123576 discloses a data processing device that guarantees sufficient data read time by setting the time assigned to a read operation within one cycle to be longer than 0.5 cycle. Further, Japanese Patent Laying-Open No. 09-128977 discloses a synchronous SRAM that adopts a late write method, where after determination of a write address of data, when a next write address is designated, data is written into the latest determined write address, and that adjusts a timing to access a memory cell in accordance with a read operation or a write operation with respect to the memory cell, to thereby optimize the overall operation time while guaranteeing the time required for the read operation.

In the data processing device disclosed in Japanese Patent Laying-Open No. 2000-123576, the data read time is guaranteed by reducing the precharge time of the memory circuit within one cycle to thereby increase the read time. If the clock frequency is increased to accelerate the operation, however, the time corresponding to one cycle will decrease, and accordingly, the data read time will be shortened. This poses a problem that the operation cannot readily be accelerated in the data processing device disclosed in Japanese Patent Laying-Open No. 2000-123576.

The synchronous SRAM disclosed in Japanese Patent Laying-Open No. 09-128977 adjusts the timing to access the memory cell. However, the precharge and data reading from a memory cell are each conducted in one cycle of the clock signal, as in the conventional semiconductor device. This means that the operation cannot readily be accelerated in the synchronous SRAM disclosed in Japanese Patent Laying-Open No. 09-128977, as in the case of the data processing device disclosed in Japanese Patent Laying-Open No. 2000-123576.

Further, although the synchronous SRAM of Japanese Patent Laying-Open No. 09-128977 firstly determines address for writing data writing to the determined address is conducted only after the address for next writing is determined. This synchronous SRAM requires a register used only to hold the once determined address, resulting in an increase of the circuit scale.

### SUMMARY OF THE INVENTION

An object of the present invention is to provide a semiconductor device that can increase the data read speed while guaranteeing sufficient data read time from a memory circuit to a data bus.

In summary, the present invention provides a semiconductor device, which includes a data bus transmitting data, a processor, a memory circuit, and a control circuit. The processor performs data sending/receiving with respect to the data bus, performs address designation corresponding to the data sending/receiving, and outputs an operation signal instructing one of a read operation and a write operation. The memory circuit outputs the data to the data bus after a prescribed delay time in response to the address designation corresponding to the read operation, and inputs the data from the data bus in response to address designation subsequent to the address designation corresponding to the write operation. The control circuit, when the operation signal is switched from the write operation to the read operation, causes the memory circuit to output the data with a delay that is longer than the prescribed delay time.

Accordingly, the primary benefit of the present invention is that the read speed can be increased while securing sufficient data read time from the memory circuit to the data bus.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing a configuration of a main part of a semiconductor device according to an embodiment of the present invention.

FIG. 2 shows a part of a configuration of a memory circuit 4.

FIG. 3 is a timing chart illustrating an operation of the semiconductor device according to the embodiment.

FIG. 4 is a timing chart illustrating a problem that may arise during the operation of the semiconductor device according to the embodiment.

FIG. 5 is a timing chart illustrating another operation of the semiconductor device according to the embodiment.

FIG. 6 is a timing chart illustrating yet another operation of the semiconductor device according to the embodiment.

FIG. 7 shows a configuration of a main part of a microcomputer.

FIG. 8 is a timing chart illustrating an operation of the microcomputer 100 in FIG. 7.

### DESCRIPTION OF THE PREFERRED EMBODIMENTS

Hereinafter, an embodiment of the present invention will be described with reference to the drawings, where the same reference characters denote the same or corresponding portions.

### Embodiment

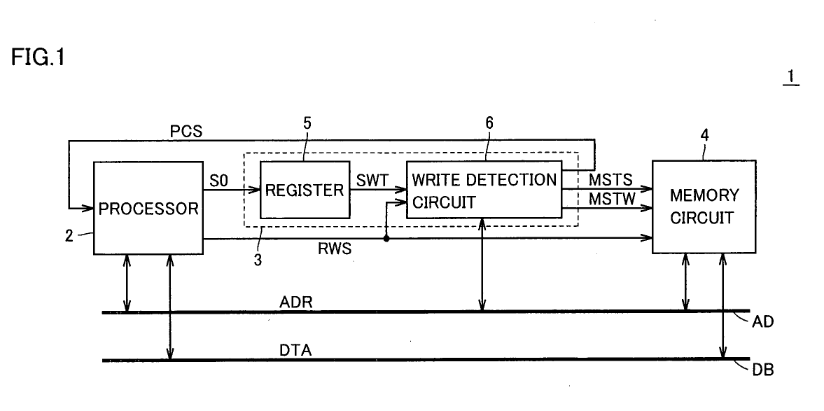

Referring to FIG. 1, a semiconductor device 1 according to an embodiment of the present invention includes a processor 2, a control circuit 3, a memory circuit 4, an address bus AD transmitting an address signal ADR from processor 2 to memory circuit 4, and a data bus DB transmitting data between processor 2 and memory circuit 4.

Processor 2 sends a signal RWS to memory circuit 4. Memory circuit 4 selects whether to output data to data bus DB or input data from data bus DB, in accordance with the logical level of signal RWS.

Memory circuit 4 receives address signal ADR from address bus AD as well, and performs input/output of data with respect to the designated address. The read and write operations of memory circuit 4 will be described later.

Control circuit 3 includes a register 5 and a write detection circuit 6. Processor 2 outputs a signal S0 indicating whether to use write detection circuit 6 or not. Register 5 temporarily holds the content of signal S0. Signal S0 is output from register 5 as a signal SWT, which is sent to write detection circuit 6. In receipt of signal SWT, write detection circuit 6 conducts or stops an operation in accordance with the logical level of signal SWT. Note that the content of signal SWT is identical to that of signal S0.

Signal S0 being applied from processor 2 to register 5 includes a write signal and write data. Writing to register 5 is carried out according to a program executed within semiconductor device 1. The content of signal S0 being held at register 5 is rewritten in accordance with the write data.

Write detection circuit 6 receives signal SWT, and outputs to memory circuit 4 a signal MSTW for designating modification in timing of the read or write operation. When signal MSTW is “1”, memory circuit 4 performs data read/write at an operation timing as will be described later. If signal MSTW is “0”, memory circuit 4 performs data read/write at a conventional operation timing (one cycle access). Note that signal MSTW and signal SWT switch between “0” and “1” at the same timing. That is, when processor 2 instructs write detection circuit 6 to operate, write detection circuit 6 instructs memory circuit 4 to change the operation timing, and thus, memory circuit 4 changes the operation timing from the one cycle access to the operation timing as will be described later.

Write detection circuit 6 also receives signal RWS from processor 2. When signal RWS is switched from the write operation to the read operation, write detection circuit 6 outputs to memory circuit 4 a signal MSTS to make it wait to perform the read operation. Memory circuit 4 waits, while signal MSTS is “1”, to read data from the designated address.

Write detection circuit 6 also sends signal PCS to processor 2. In receipt of signal PCS, processor 2 determines whether to access data bus DB or not, in accordance with the logical level of signal PCS. The timing of sending signal PCS will be described later.

Note that processor 2 is not restricted to the above-described CPU; it may be e.g. a digital signal processor (DSP). Further, although memory circuit 4 is explained as being an SRAM in the following, it is not restricted thereto. For example, memory circuit 4 may be a dynamic random access memory (DRAM) or a flash memory.

Although not shown in FIG. 1, semiconductor device 1 further includes a clock generation circuit that generates a clock signal to synchronize the operations of processor 2 and memory circuit 4, and others. Processor 2, control circuit 3 and memory circuit 4 each operate in synchronization with the clock signal supplied from the clock generation circuit.

Hereinafter, an operation of the semiconductor device of FIG. 1 is generally explained. In a read operation, memory circuit 4 successively performs precharge, sense operation and data output operation, each in 0.5 cycle of the clock signal. It conducts the data output operation and the precharge for a next read operation at the same time. In doing so, memory circuit 4 can address acceleration of the operation, while guaranteeing sufficient time for the sense operation. Write detection circuit 6, in response to switching from the write operation to the read operation, sends signal MSTW to memory circuit 4 to make it delay the read operation. Memory circuit 4 delays the read operation by one cycle of the clock signal, to prevent destruction of the write data. Further, write detection circuit 6 sends signal PCS to processor 2, to make it stop access to data bus DB while the read operation is being delayed.

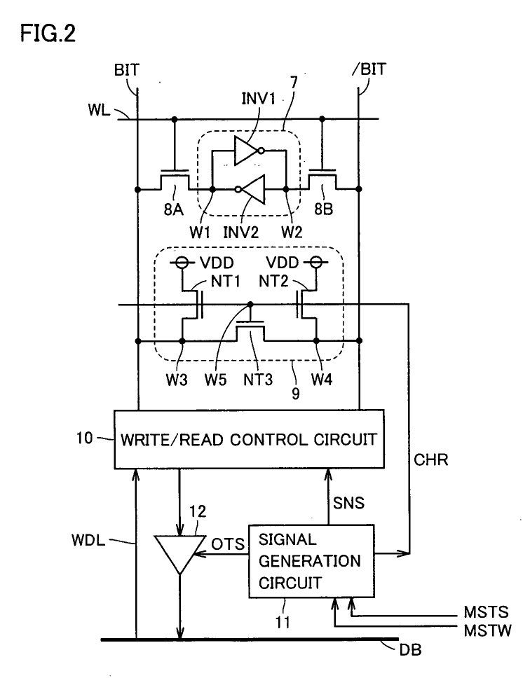

FIG. 2 shows a part of a configuration of memory circuit 4. An SRAM circuit is shown in FIG. 2 as an example of memory circuit 4.

Referring to FIG. 2, selectors 8A, 8B are connected to bit lines BIT, /BIT, respectively, which output information of a memory cell 7 to bit lines BIT, /BIT when a word line WL is selected.

Memory cell 7 includes an inverter INV1 having an input connected to a node W1 and an output connected to a node W2, and an inverter INV2 having an input connected to node W2 and an output connected to node W1.

A write/read control circuit 10 is connected to bit lines BIT, /BIT to conduct a read operation or a write operation with respect to memory cell 7. Write/read control circuit 10 includes, among others, a sense amplifier amplifying a voltage difference caused between bit lines BIT, /BIT when data is read out of memory cell 7, and a driver for conducting a write operation to memory cell 7.

A signal generation circuit 11 is connected to write/read control circuit 10. Signal generation circuit 11 receives signals MSTS and MSTW from write detection circuit 6 in FIG. 1, and generates a signal CHR for activating precharge circuit 9 to conduct precharge, a signal SNS for causing write/read control circuit 10 to perform the sense operation, and a signal OTS for causing an output buffer 12, temporarily holding data read out of memory cell 7, to output the data to data bus DB.

When data is to be written into memory cell 7, or when data is to be read out of memory cell 7, firstly, precharge circuit 9 sets voltages of bit lines BIT, /BIT to a prescribed voltage (e.g., a power supply voltage VDD).

In the read operation, word line WL is then selected, rendering selectors 8A, 8B conductive. Before conduction of selectors 8A, 8B, one and the other of nodes W1 and W2 are “1” and “0”, respectively.

For example when node W2 is “0”, upon conduction of selectors 8A and 8B, the voltage of bit line /BIT becomes lower than that of bit line BIT.

When signal SNS is activated, a sense amplifier (not shown) included in write/read control circuit 10 is activated. The sense amplifier amplifies the voltage difference caused between bit lines BIT and /BIT to a level required to determine whether it corresponds to “0” or “1”.

The data read out of memory cell 7 is output from write/read control circuit 10, and held in output buffer 12. Output buffer 12, in receipt of signal OTS from signal generation circuit 11, outputs the data held therein, to data bus DB.

Signal generation circuit 11 outputs signal OTS in response to signals MSTS, MSTW received from write detection circuit 6 of FIG. 1. When signal MSTW is “1”, i.e., when write detection circuit 6 is in an operating state, signal generation circuit 11 stops outputting of signal CHR as well as outputting of signal OTS while signal MSTS is “1”.

In the write operation to memory cell 7, as in the case of the read operation, signal generation circuit 11 activates signal CHR to thereby activate precharge circuit 9. Precharge circuit 9 receives signal CHR and sets the voltages of bit lines BIT, /BIT to a prescribed voltage. Data is then transmitted from data bus DB to write/read control circuit 10 via a data transmission line WDL dedicated to data writing. When selectors 8A, 8B become conductive with word line WL selected, write/read control circuit 10 sends data to bit lines BIT, /BIT, so that the voltages of nodes W1, W2 change. Selectors 8A, 8B then become non-conductive, and the data writing is completed.

Address signal ADR shown in FIG. 1 is input e.g. to an address buffer (not shown in FIG. 2) for generating a row address and a column address. Signal RWS is input to a control circuit (not shown in FIG. 2) within the memory circuit for generating a control signal.

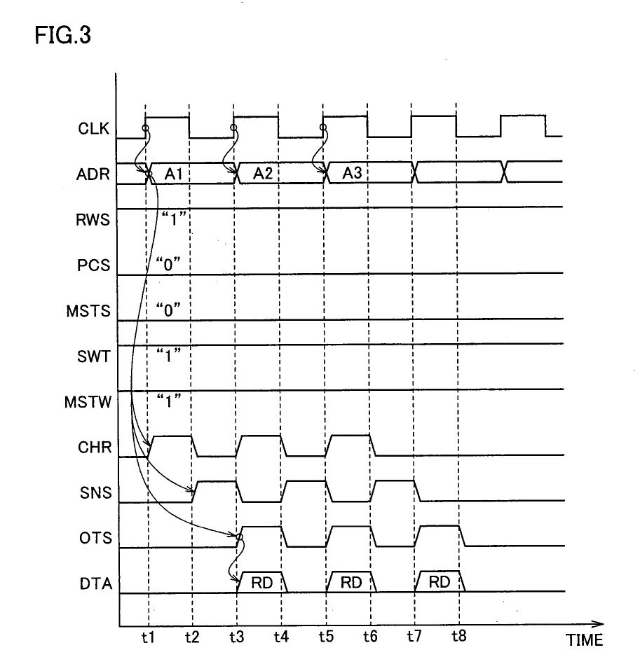

FIG. 3 is a timing chart illustrating an operation of the semiconductor device of the present embodiment.

The timing chart of FIG. 3 shows the operation of memory circuit 4 when data reading is instructed continuously from processor 2 of FIG. 1 to memory circuit 4.

Referring to FIG. 3, firstly, when clock signal CLK rises at time t1, address signal ADR is switched to define an address A1. Signal RWS is “1” indicating the read operation at time t1, so that the read operation with respect to address A1 is started. At time t1, signal CHR rises in response to switching of address signal ADR, and precharge is conducted. Address A1 is an arbitrary address of memory circuit 4.

Note that the content of register 5: in FIG. 1 is not rewritten while memory circuit 4 is operating. Processor 2 rewrites the content of register 5, before accessing memory circuit 4, according to a program that is held outside the region of memory circuit 4, for example in a non-volatile memory (ROM). Processor 2 starts access to memory circuit 4 after completion of rewriting of the content of register 5. Thus, in FIG. 3, signal SWT is always “1” while write detection circuit 6 is operating. Signal MSTW and signal SWT have the same content. Thus, signal MSTW is also constantly.

Further, signal PCS is “0” at time t1. This means that processor 2 is in a state accessible to data bus DB. Signal MSTS is “o”, indicating that the output of data from memory circuit 4 to data bus DB is possible.

At time t2, signal SNS-rises, and the sense operation is conducted. At time t2, the data stored in memory cell 7 is amplified by the sense amplifier to determine whether it is “0” or “1”. The data is temporarily held in output buffer 12.

In the one cycle access operation shown in FIG. 8, signal OTS rises along with the rise of signal SNS. In contrast, in FIG. 3, signal OTS remains “0” at time t2, so that the data held in output buffer 12 is not output to data bus DB.

At time t3, signal OTS rises, and the data held in output buffer 12 is output to data bus DB. The data output to data bus DB becomes read data RD being read out to processor 2.

Further, at time t3, address signal ADR is switched to designate an address A2. As in the operation at time t1, signal CHR rises at time t3, and the precharge is started. That is, during the time period from t3 to t4, memory circuit 4 outputs read data RD to data bus DB, and conducts the precharge as well.

At time t5, address signal ADR is switched to designate an address A3, and the read operation is started.

In the read operation after time t3, the read operation the same as that conducted during the time period from t1 to t4 is repeated. Thus, description of the read operation after time t3 will not be repeated.

As shown in time t1 through time t4, memory circuit 4 performs precharge from time t1 to time t2, the sense operation from time t2 to time t3, and the data output operation from time t3 to time t4. These operations with respect to address A1 are conducted without overlapping with each other. In the conventional one cycle access, as shown in FIG. 8, the sense operation and the data output operation are conducted at the same timing (time t2 to time t3 in FIG. 8). Thus, when the sense amplifier included in write/read control circuit 10 of FIG. 2 operates at a low speed, the sense operation takes time, resulting in delay of the data output to data bus DB.

By comparison, in the timing chart of FIG. 3, the sense operation, conducted from time t2 to time t3, does not overlap the data output operation. Thus, even a slow sense amplifier can start the data output operation from time t3, as long as the sense operation is finished in 0.5 cycle of clock signal CLK. This can solve the problem of the delay of data output.

It however takes 1.5 cycles of clock signal CLK from the precharge to the data output operation. Thus, in order to keep the data output interval the same (one cycle) as the conventional one cycle access, in the case where the read operation is conducted continuously, the data output operation for address A1 and the precharge for reading from address A2 are carried out at the same time, as shown in time t3 to time t4.

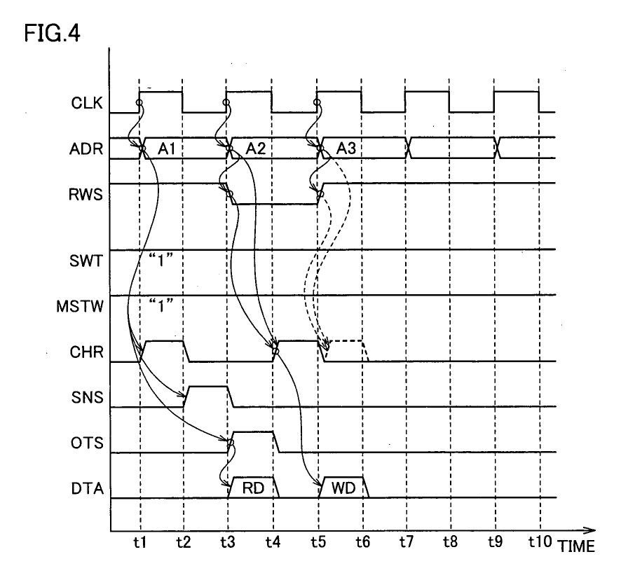

FIG. 4 is a timing chart illustrating a problem that may occur during the operation of the semiconductor device of the present embodiment.

In FIG. 4, the problem that may arise in semiconductor device 1 of FIG. 1 when memory circuit 4 switches form the read operation to the write operation is illustrated.

Referring to FIG. 4, firstly at time t1, address signal ADR is switched, and the read operation with respect to address A1 is started. The read operation during time t1 to time t4 is the same as that conducted during time t1 to time t4 in FIG. 3, and thus, description thereof is not repeated.

At time t3, address signal ADR is switched to define address A2. At time t3, signal RWS falls to “0”. Thus, the data write with respect to address A2 is conducted.

At time t4, signal CHR rises, and the precharge is conducted. At time t5, write data WD is output from processor 2 to data bus DB, and memory circuit 4 acquires write data WD form data bus DB.

At time t5, address A3 is designated, and signal RWS is switched to “1”. Thus, the data read with respect to address A3 is designated.

However, if signal CHR rose in response to switching of address signal ADR as shown by dotted lines in FIG. 4, precharge circuit 9 would conduct precharge for bit lines BIT, /BIT. In this case, during the time from t5 to t6, the precharge voltage would destroy write data WD on bit lines BIT, /BIT having been acquired from data bus DB. There is a need to solve such a problem.

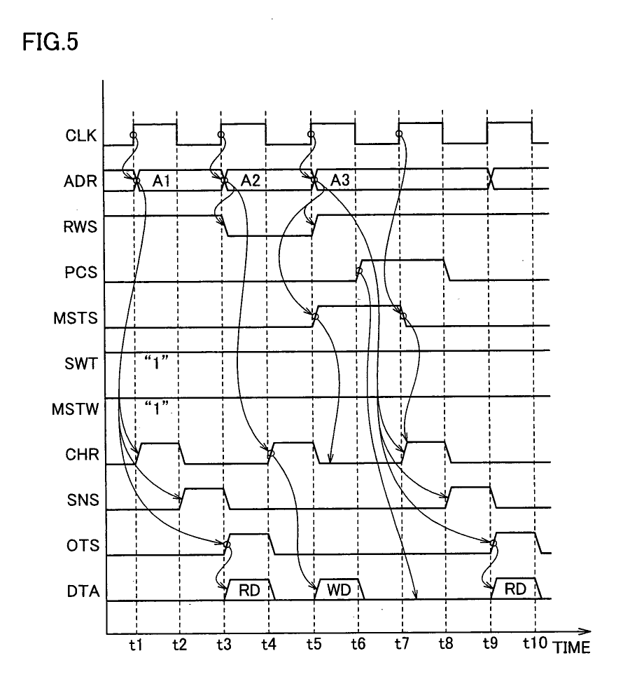

FIG. 5 is a timing chart illustrating another operation of the semiconductor device of the present embodiment. The timing chart of FIG. 5 shows a way to solve the problem described in conjunction with FIG. 4.

Referring to FIG. 5, the operation of semiconductor device 1 during the time period from t1 to t5 is identical to that during the time period from t1 to t5 in FIG. 4, and thus, description thereof is not repeated.

At time t5, when address signal ADR is switched, the read operation with respect to address A3 is designated. At time t5, write detection circuit 6 in FIG. 1 detects switching of signal RWS to “1”, and switches signal MSTS from “0” to “1”. Signal generation circuit 11 in FIG. 2, in response to signal MSTS having attained “1”, stops the output of signal CHR, so that precharge circuit 9 does not perform precharge on bit lines BIT, /BIT. Write data WD acquired from data bus DB is transmitted through bit lines BIT, /BIT and written into memory cell 7.

Write detection circuit 6 sets signal MSTS to “1” at time t5, and switches signal PCS to “1” at time t6.

If signal PCS were “0”, processor 2 would access data bus DB at time t7 aiming at reading the data output from address A3. Time t7 corresponds to the time when the data would be output to data bus DB if precharge were started at time t5. However, if the precharge is started at time t5, the write data will be destroyed, as explained above in conjunction with the timing chart of FIG. 4. Therefore, write detection circuit 6 sets signal MSTS to “1” at time t5 to delay the read operation of memory circuit 4. Processor 2 however cannot detect that the read operation in memory circuit 4 is being delayed.

Thus, in order to notify processor 2 that the read operation in the memory circuit is in delay, write detection circuit 6 sets signal PCS to “1” at time t6. Processor 2 refrains from acquiring data from data bus DB while signal PCS is “1”, so that the situation where data is erroneously read on the processor 2 side is prevented.

At time t7, write detection circuit 6 sets signal MSTS to “0”, and causes memory circuit 4 to start the data read with respect to address A3. At time t7, signal CHR rises, and the precharge for bit lines BIT, /BIT is performed. The subsequent read operation is identical to that during the time period from t1 to t4, and thus, description thereof is not repeated.

Further, write detection circuit 6 switches signal PCS from “1” to “0” in response to falling of clock signal CLK at time t8. This enables processor 2 to acquire data from data bus DB again.

As described above, write detection circuit 6 in FIG. 1 functions to control the operations of processor 2 and memory circuit 4. The reason why such control is conducted by write detection circuit 6 is now explained.

In an ordinary processor, the number of cycles of the clock signal required to read/write data with respect to a memory circuit in synchronization with the clock signal is fixed, regardless of whether the memory circuit is external or built-in. Further, the processor generally holds a plurality of patterns regarding the numbers of cycles of the clock signal required for data input/output operations with respect to the data bus.

The processor only performs access to the data bus in the fixed number of cycles of the clock signal. It does not confirm the state of the memory circuit. The processor and the memory circuit, however, operate in synchronization with the clock signal. Thus, if they both transmit data to the data bus, data exchange can be performed properly, as long as the data read/write operations in each of the processor and the memory circuit match in timing with each other.

Now, assume that the memory circuit operating in the manner as shown from time t3 to time t6 in FIG. 5, where the data write with respect to address A2 is conducted one clock cycle after determination of the write address A2 (i.e., conducted upon determination of address A3) is externally provided to a conventional processor. In this case, the processor will attempt to perform data read/write with respect to the memory circuit in accordance with the conventional one cycle access.

If the memory circuit as descried above is employed without provision of means for notifying the processor of the one-cycle waiting time, the processor will output an address for the write operation, and one clock cycle later, will output an address for a next read operation. The memory circuit, however, will not output data to the data bus, since it is in the waiting state.

The processor will nevertheless conduct the read operation, according to the conventional one cycle access, during the time where the memory circuit is in the waiting state. That is, there will occur mismatch in operation between the processor and the memory circuit.

As a way to solve such a problem, the processor may be configured to perform processing in accordance with a dedicated program stored e.g. in a read only memory (ROM), or the memory circuit may be provided with a register dedicated to hold the write address as in the synchronous SRAM disclosed in Japanese Patent Laying-Open No. 09-128977 described above, so as to make sending/receiving of the addresses and data between the processor and the memory circuit match with each other. Provision of the non-volatile memory or the dedicated register, however, will increase the circuit scale, leading to increased power consumption as well as increased manufacturing cost.

In contrast, according to semiconductor device 1 of the present embodiment, write detection circuit 6 controls the access of processor 2 to data bus DB. Thus, even in the case where the memory circuit performing the data read/write operations in a manner other than the one cycle access is combined with a conventional processor, control circuit 3 in FIG. 1 can further be combined to make it readily possible to ensure match in data read/write between processor 2 and memory circuit 4, regardless of whether memory circuit 4 is externally provided to processor 2 or built therein.

Further, the operation of processor 2 to stop access to data bus DB can readily be implemented using a bus access control circuit that is normally provided in a processor. It is possible for the processor to set the waiting time, from the start of a process for accessing the data bus until the execution of the access, to correspond to one clock cycle, or to eliminate such a waiting time. As such, by causing the bus access control circuit to operate in accordance with the signal PCS supplied from write detection circuit 6, processor 2 can readily maintain the match in data read/write with memory circuit 4. Further, write detection circuit 6 can be implemented with a small-size circuit.

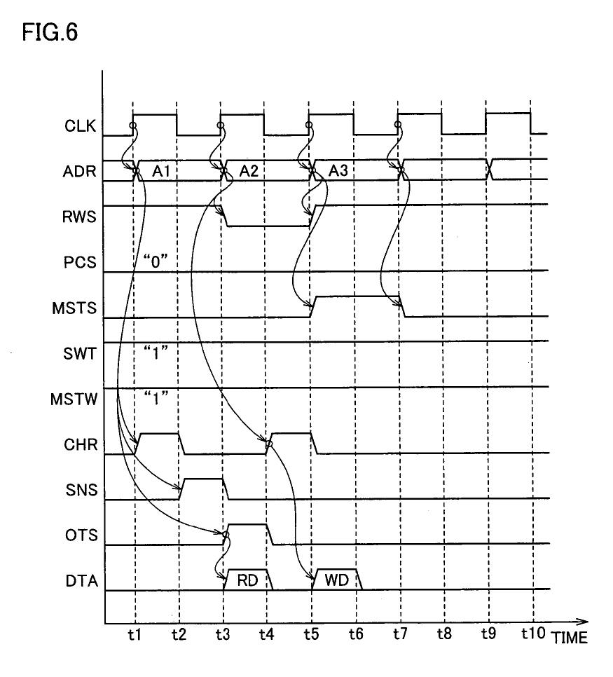

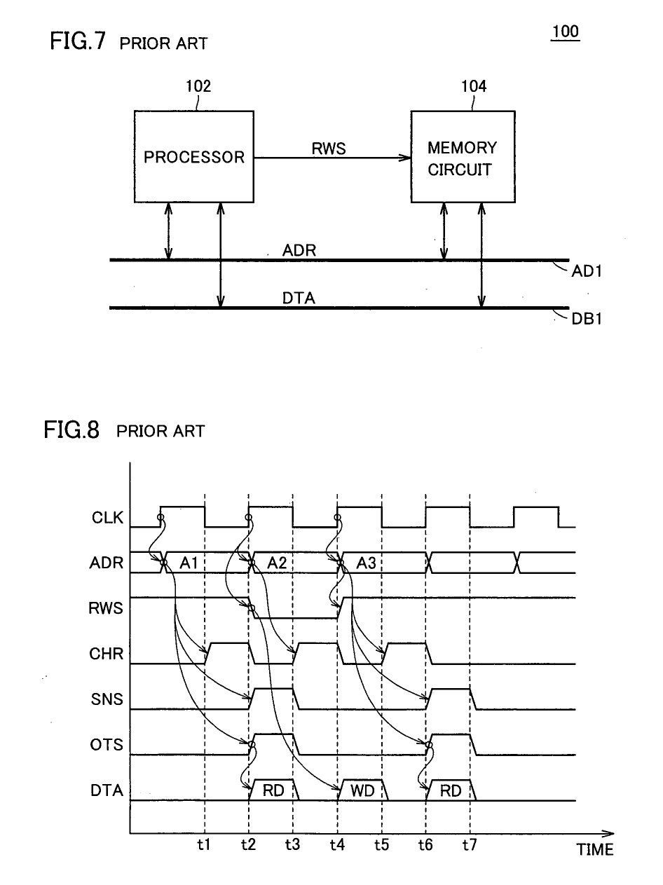

FIG. 6 is a timing chart illustrating yet another operation of the semiconductor device of the present embodiment.

Processor 2 may access, besides memory circuit 4 shown in FIG. 1, a read only memory (ROM) storing a program, for example. The timing chart in FIG. 6 illustrates the operation in the case where processor 2 access e.g. a ROM after completion of the write operation to memory circuit 4.

Referring to FIG. 6, the read and write operations of semiconductor device 1 during the time period from t1 to t6 are identical to those in the time period from t1 to t6 in FIG. 5, and thus, description thereof is not repeated.

At time t5, address signal ADR is switched upon rising of clock signal CLK, and an access to a circuit other than memory circuit 4 (e.g., the above-described ROM) is started.

Addresses A2, A3 designated in FIG. 5 are those of memory circuit 4. Thus, at time t6 in FIG. 5, write detection circuit 6 sets signal PCS to “1” to prevent processor 2 from accessing data bus DB.

By comparison, at time t5 in FIG. 6, address signal ADR is switched, to designate an address of the ROM this time. Signal PCS remains “0” at time t6. Thus, processor 2 can access data bus DB.

At time t5, write detection circuit 6 switches signal MSTS to “1”. Since memory circuit 4 does not conduct precharge at time t5, ideally write detection circuit 6 does not need to set signal MSTS to “I” at time t5.

However, there is a possibility that signal CHR may rise in response to the rising of clock signal CLK at time t5 when the switching of address signal ADR is behind time t5. Thus, in order to prevent the situation where the precharge in response to the rising of signal CHR destroys write data WD transmitted on bit lines BIT, /BIT, write detection circuit 6 outputs signal MSTS of “1” during the time period from t5 to t7. This delays the read operation of memory circuit 4 by one cycle, which ensures safer data write.

Although the present invention has been described and illustrated in detail, it is clearly understood that the same is by way of illustration and example only and is not to be taken by way of limitation, the spirit and scope of the present invention being limited only by the terms of the appended claims.

1. A semiconductor device, comprising:
a data bus transmitting data;
a processor performing data sending/receiving with respect to said data bus, performing address designation corresponding to said data sending/receiving, and outputting an operation signal instructing one of a read operation and a write operation;
a memory circuit outputting said data to said data bus in response to the address designation corresponding to said read operation after a prescribed delay time, and inputting said data from said data bus in response to address designation subsequent to the address designation corresponding to said write operation; and
a control circuit, when said operation signal is switched from said write operation to said read operation, causing said memory circuit to output said data with a delay that is longer than said prescribed delay time.

2. The semiconductor device according to claim 1, wherein
said control circuit operates in synchronization with a clock signal, and
said control circuit includes a detection circuit detecting switching of said operation signal from said write operation to said read operation, and outputting a wait signal causing said memory circuit to wait one cycle of said clock signal to output said data.

3. The semiconductor device according to claim 2, wherein said detection circuit, in response to an output of said wait signal, further outputs to said processor a stop signal causing said processor to stop said data sending/receiving.

4. The semiconductor device according to claim 1, wherein
said memory circuit includes
a plurality of memory cells arranged in rows and columns,
a plurality of bit line pairs arranged corresponding to said columns,
a precharge circuit conducting precharge of said plurality of bit line pairs,
a read circuit reading said data stored in each of said plurality of memory cells via said plurality of bit line pairs,
an output circuit receiving said data from said read circuit and outputting the received data to said data bus, and
a signal generation circuit outputting a control signal causing said precharge circuit, said read circuit and said output circuit to successively operate in 0.5 cycle each of the clock signal to carry out said read operation.

5. The semiconductor device according to claim 4, wherein said memory circuit is an SRAM circuit.
